(19) United States
(12) Patent Application Publication
(10) Pub. No.: US 2008/0107579 A1
(43) Pub. Date: May 8, 2008

(54) Bromine Addition for the Improved Removal of Mercury from Flue Gas

(76) Inventors: William Downs, Alliance, OH (US); George Albert Farthing, Alliance, OH (US)

Correspondence Address: Eric Marich;The Babcock & Wilcox Company, 20 south Van Buren Avenue, Barrenton, OH, 44203, US

(21) Appl. No.: 10/591,855

(22) PCT Filed: Mar. 21, 2005
(86) PCT No.: PCT/US05/09590

§ 371 Date: Sep. 5, 2006

Related U.S. Application Data
(60) Provisional application No. 60/555,353, filed on Mar. 22, 2004.

(51) Int. Cl. B01D 47/00

(52) U.S. Cl. 423/210

(57) ABSTRACT

Bromine-containing compounds, added to the coal, or to the boiler combustion furnace, are used to enhance the oxidation of mercury, thereby enhancing the overall removal of mercury in downstream pollution control devices. The method is applicable to utility power plants equipped with wet FGD systems, as well as those plants equipped with spray dryer absorber FGD systems.

### FIELD AND BACKGROUND OF THE INVENTION

Emissions Standards, as articulated in The Clean Air Act Amendments of 1990 as established by the U.S. Environmental Protection Agency (EPA), required assessment of hazardous air pollutants from utility power plants. In December 2000 the EPA announced their intention to regulate mercury emissions from coal-fired utility boilers. Coal-fired utility boilers are a known major source of anthropogenic mercury emissions in the United States. Elemental mercury and many of its compounds are volatile and will therefore leave the boiler as trace constituents in boiler flue gases. Some of these mercury constituents are insoluble in water, which renders them difficult to capture in conventional wet and dry scrubbers. Thus new methods and processes are needed to capture these trace constituents from boiler flue gases.

Mercury appears in coal combustion flue gases in both solid and gas phases (particulate-bound mercury and vapor-phase mercury, respectively). The so called particulate-bound mercury is really vapor-phase mercury adsorbed onto the surface of ash or carbon particles. Due to the high volatility of mercury and many of its compounds, most of the mercury found in flue gases is vapor-phase mercury. Vapor-phase mercury can appear as elemental mercury (elemental, metallic mercury vapor) or as oxidized mercury (vapor-phase species of various compounds of mercury). Speciation, which refers to the form of mercury present, is a key parameter in the development and design of mercury control strategies. All efforts to devise new control strategies for mercury emissions from power plants must focus on this characteristic of mercury.

Particulate collectors in use at electric utility plants, most commonly electrostatic precipitators (ESP) or fabric filters (FF), sometimes called baghouses, provide high-efficiency removal of particulate-bound mercury. Fabric filters tend to exhibit better particulate laden mercury removal than ESPs by providing a filter cake upon which to trap the particulate mercury as the flue gas passes through said filter cake. If the filter cake also contains constituents that will react with mercury such as unreacted carbon or even activated carbon, then the filter cake can act as a site to facilitate gas-solid reactions between the gaseous mercury and the solid carbon particles. If a power plant is equipped with a Flue Gas Desulfurization System (FGD) then either wet scrubbers or spray dryer absorbers (SDA) can remove significant amounts of oxidized mercury. Oxidized mercury, typically appearing in the form of mercuric chloride, is soluble in water, making it amenable to removal in sulfur dioxide scrubbers. Elemental mercury, insoluble in water, is less likely to be scrubbed in; conventional scrubbers. Removal of elemental mercury, therefore, remains an important issue in the search for cost-effective mercury control techniques.

Numerous studies have been, and continue to be, conducted to develop cost-effective approaches to the control of elemental mercury. Many of the studies have focused on the injection of a carbonaceous sorbent (e.g., powdered activated carbon, or PAC) into the flue gas upstream of the dust collector to adsorb vapor-phase mercury. The sorbent, and its burden of adsorbed mercury, are subsequently removed from the flue gases in a downstream particulate collector. Adsorption is a technique that has often been successfully applied for the separation and removal of trace quantities of undesirable components. PAC injection is used, commercially, to remove mercury from municipal waste combustor exhaust gases. PAC injection removes both oxidized and elemental mercury species, although removal efficiencies are higher for the oxidized form. Although this approach appeared attractive in early work, the economics of high injection rates can be prohibitive when applied to coal-fired utility plants. More refined studies are now in progress to define more precisely what can and cannot be achieved with PAC. Still other studies seek to enhance PAC technology. One technique subjects the PAC to an impregnation process wherein elements such as iodine or sulfur are incorporated into the carbonaceous sorbent. Such processes can yield sorbents that more strongly bond with adsorbed mercury species, but also result in significantly higher sorbent cost.

The speciation of vapor-phase mercury depends on coal type. Eastern U.S. bituminous coals tend to produce a higher percentage of oxidized mercury than do western subbituminous and lignite coals. Western coals have low chloride content compared to typical eastern bituminous coals. It has been recognized for several years that a loose empirical relationship holds between the chloride content of coal and the extent to which mercury appears in the oxidized form. FIG. 1 (Source: Senior, C. L. Behavior of Mercury in Air Pollution Control Devices on Coal-Fired Utility Boilers, 2001) illustrates the relationship between coal chlorine content and vapor-phase mercury speciation. An important reason for the significant scatter in the data of FIG. 1 is that mercury oxidation depends in part on the specific characteristics of the boiler as well as the fuel. The mercury oxidation reactions proceed by both homogeneous and heterogeneous reaction mechanisms. Factors such as boiler convection pass and combustion air preheater temperature profiles, flue gas composition, fly ash characteristics and composition, and the presence of unburned carbon have all been shown to affect the conversion of elemental mercury to oxidized mercury species.

Felsvang et al. (U.S. Pat. No. 5,435,980) teaches that the mercury removal of a coal-fired system employing an SDA system can be enhanced by increasing the chlorine-containing species (e.g., hydrogen chloride) in the flue gases. Felsvang et al. further teaches that this can be accomplished through the addition of a chlorine-containing agent to the combustion zone of the boiler, or through the injection of hydrochloric acid (HCl) vapor into the flue gases upstream of the SDA. These techniques are claimed to improve the mercury removal performance of PAC when used in conjunction with an SDA system.

### SUMMARY OF THE INVENTION

It is an object of this invention to invention to yield significant technical and commercial advantages over the prior art. The present inventors have determined through experimental testing that the use of bromine-containing compounds, added to the coal, or to the boiler combustion furnace, are significantly more effective than chlorine-containing compounds in enhancing the oxidation of mercury, thereby enhancing the overall removal of mercury in downstream pollution control devices. Second, the technique is applicable to utility power plants equipped with wet FGD systems, as well as those plants equipped with SDA systems. Wet FGD is the sulfur dioxide removal system of choice for most coal-fired utilities around the world. Approximately 25% of the coal-fired electric power plants in the U.S. are equipped with wet FGD systems.

The various features of novelty which characterize the invention are pointed out with particularity in the claims annexed to and forming a part of this disclosure. For a better understanding of the present invention, its operating advantages and the specific benefits attained by its uses, reference is made to the accompanying drawings and descriptive matter in which preferred embodiments of the invention are illustrated.

### BRIEF DESCRIPTION OF THE DRAWINGS

FIG. 1 is a graph illustrating the relationship between coal mercury content and mercury speciation for U.S. coals;

FIG. 2 is a schematic illustration of a first embodiment of the present invention involving bromine addition for the improved removal of mercury from flue gases;

FIG. 3 is a graph of test data illustrating the effect of the addition of a particular halogen, calcium bromide, CaBr₂, on the total vapor-phase mercury produced during the combustion of coal, according to the present invention;

FIG. 4 is a schematic illustration of a coal-fired electric utility plant configuration comprising a boiler equipped with an SDA and a downstream particulate collection means such as a fabric filter (FF) or an electrostatic precipitator (ESP);

FIG. 5 is a schematic illustration of a coal-fired electric utility plant configuration comprising a boiler equipped with a downstream particulate collection means such as a fabric filter (FF) or an electrostatic precipitator (ESP); and

FIG. 6 is a schematic illustration of a coal-fired electric utility plant configuration comprising a boiler equipped with a downstream particulate collection means such as a fabric filter (FF) or an electrostatic precipitator (ESP) and a wet flue gas desulfurization (FGD) system.

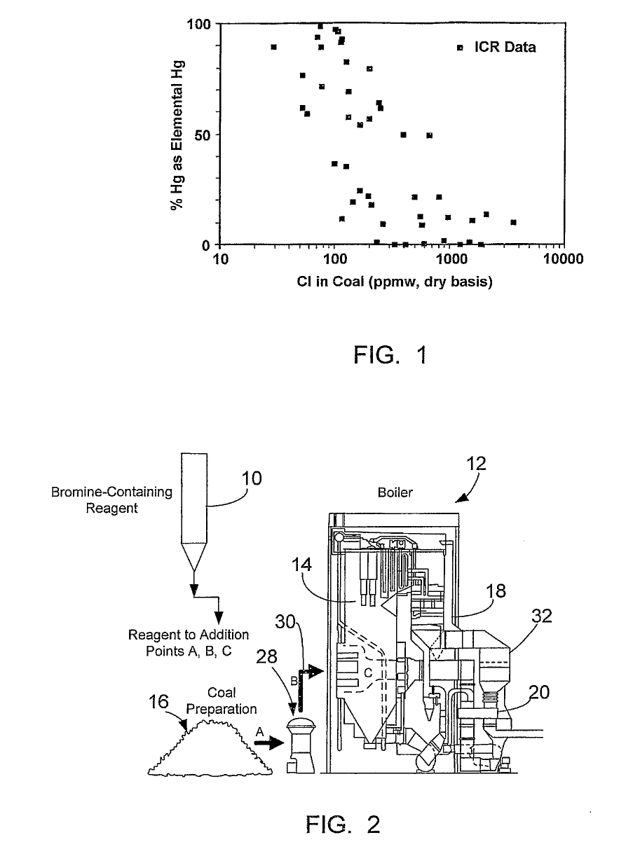

### DETAILED DESCRIPTION OF THE PREFERRED EMBODIMENTS

Referring to the drawings generally, wherein like numerals designate the same or functionally similar elements throughout the several drawings, a first embodiment of the present invention is illustrated in FIG. 2. A bromine-containing reagent 10 is added to the boiler 12 combustion furnace 14, either directly or by premixing with the incoming coal 16. Bromine species released during the combustion process enhance the oxidation of mercury as the combustion gases pass through the furnace 14 and, in particular, through the cooler sections of the boiler convection pass 18 and combustion air preheater 20. The increased fraction of mercury appearing in the oxidized form enhances mercury removal in downstream pollution control systems such as wet 22 and SDA 24 FGD systems, and PAC injection systems. As is described herein, experimental results indicate that bromine addition also results in an increased fraction of particulate-bound mercury. This enhances removal of mercury across particulate collectors 26 such as fabric filters (FF) and electrostatic precipitators (ESP).

The removal of elemental mercury from coal combustion gases generated by electric utility plants through the application of a conventional PAC injection process is very expensive. The present invention promises to significantly reduce the cost of mercury removal at coal-fired electric plants in two ways. First, increasing the fraction of mercury appearing in the oxidized and particulate-bound forms enhances the removal of mercury in conventional pollution control systems such as particulate collectors 26 and wet 22 and SDA 24 FGD systems. This reduces, or may eliminate entirely, the need for PAC injection to remove elemental mercury. Second, the increased fraction of oxidized mercury also enhances the removal of mercury across a PAC injection process, due to the higher reactivity of oxidized mercury with PAC.

T The present invention was tested in a 5 million Btu/hr Small Boiler Simulator (SBS) Facility. The SBS was fired at approximately 4.3 million Btu/hr with a western U.S. subbituminous coal. During the tests, flue gases exiting the SBS boiler first passed through a spray dryer absorber (SDA) for removal of sulfur dioxide, and then through a fabric filter (FF) for removal of fly ash and spent sorbent from the SDA FGD system.

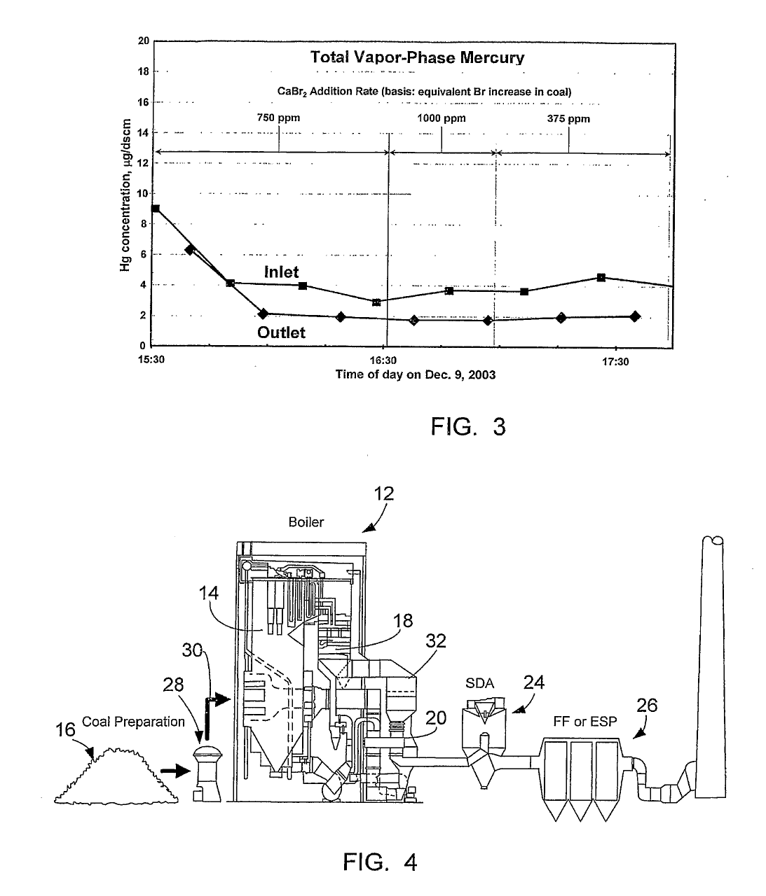

An aqueous solution of calcium bromide (CaBr₂) was injected into the combustion chamber 14 through a coal burner (not shown). FIG. 3 illustrates the removal of mercury across the SDA/FF system. It can be seen that upon injection of the calcium bromide, the vapor-phase mercury exiting the system dropped from its initial value of approximately 6 μg/dscm to about 2 μg/dscm. It can also be seen that the vapor-phase mercury at the system inlet also drops upon addition of the calcium bromide. This is due to the fact that the calcium bromide also enhances the formation of particulate-bound mercury (particulate-bound mercury does not appear on the chart, since the on-line mercury analyzer being used only detects vapor-phase mercury species.). These results identify that the current invention can offer a cost-effective method of removing elemental mercury from coal combustion flue gases.

In the preferred embodiment, an aqueous solution of calcium bromide is sprayed onto the crushed coal 16 before the coal 16 is pulverized for combustion. The aqueous solution is easily handled and metered onto the coal 16, coal pulverizers 28 intimately mix the bromide reagent 10 with the coal 16, and the pulverized coal conveying system 30 to the several coal burners (not shown) ensures an even distribution of the reagent 10 across the boiler furnace 14. There are many alternative ways to implement the invention as would be apparent to one of skill in the art. Based upon the tests performed, it is believed that adequate mercury removal can be achieved when the coal 16 is treated with up to about 1000 ppm of bromine from the bromine containing reagent 10; particularly between about 100 and about 200 ppm of bromine from the bromine containing reagent 10. As will be appreciated by those skilled in the art, some non-zero amount of bromine must be supplied in order to apply the principles of the invention; the upper limit of the range is, as a practical matter, limited by the possible increased corrosion potential which might be created.

In another embodiment the coal-fired boiler fuel 16 may include bituminous, subbituminous, and lignite coals and blends, thereof.

In yet another embodiment, the bromine-containing reagent 10 could comprise, but is not limited to, alkali metal and alkaline earth metal bromides, hydrogen bromide (HBr) or bromine (Br₂).

In yet another embodiment the bromine-containing reagent 10 may be fed to the boiler combustion zone 14 in gaseous, liquid, or solid form.

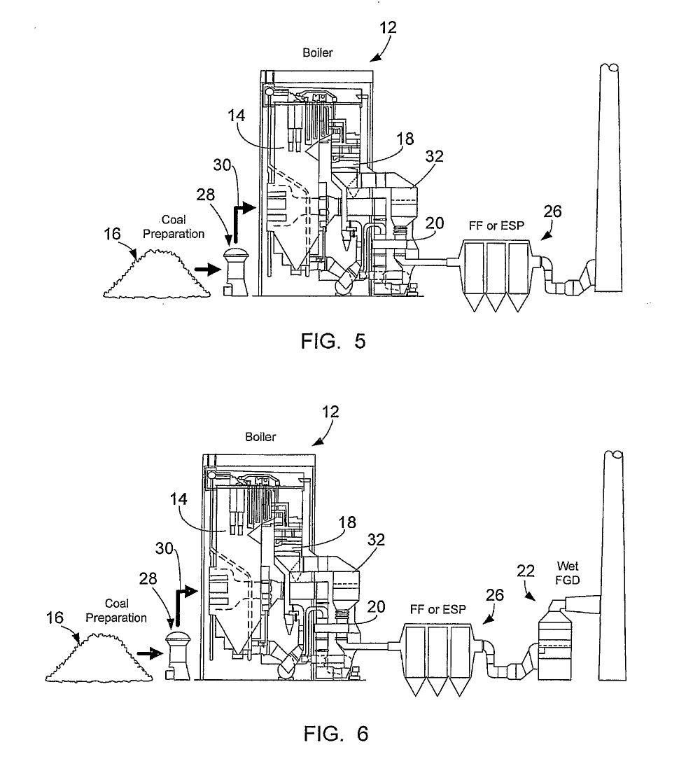

In yet another embodiment, the electric utility plant configurations may include plants equipped with an SDA 24 and particulate collector 26 (FF or ESP) (FIG. 4), a particulate collector 26 (FF or ESP) (FIG. 5), or a wet 22 FGD and particulate collector 26 (FF or ESP) (FIG. 6).

In yet another embodiment, the invention may be utilized in a coal-fired plant equipped with a selective catalytic reduction (SCR) system 32 for the control of nitrogen oxides, as SCR catalysts have been shown to promote the oxidation of elemental mercury if the correct species (in this case bromine species) are present in the flue gases.

In yet another embodiment, mercury removal may be further enhanced by utilizing a sorbent injection system in conjunction with the present invention. Such carbonaceous sorbents include, but are not limited to, powdered activated carbon (PAC), carbons and chars produced from coal and other organic materials, and unburned carbon produced by the combustion process itself.

While specific embodiments of the invention have been shown and described in detail to illustrate the application of the principles of the invention, those skilled in the art will appreciate that changes may be made in the form of the invention covered by the following claims without departing from such principles. For example, the present invention may be applied to new fossil-fueled boiler construction which requires removal of mercury from flue gases produced thereby, or to the replacement, repair or modification of existing fossil-fueled boiler installations. In some embodiments of the invention, certain features of the invention may sometimes be used to advantage without a corresponding use of the other features.

Accordingly, there are other alternative embodiments which would be apparent to those skilled in the art and based on the teachings of the present invention, and which are intended to be included within the scope and equivalents of the following claims of this invention.

We claim:

1. A method of removing a portion of the elemental mercury in a flue gas created during the combustion of a fossil fuel, comprising:
providing a bromine containing reagent to said flue gas;
promoting the oxidation of elemental mercury with the bromine containing reagent;
creating an oxidized form of mercury from the elemental mercury; and
removing the oxidized mercury from the flue gas.

2. The method according to claim 1, wherein the fossil fuel is coal.

3. The method according to claim 1, wherein the step of providing the bromine containing reagent comprises the step of treating the fossil fuel with the bromine containing reagent prior to combustion.

4. The method according to claim 1, comprising the step of treating the flue gas with the bromine containing reagent.

5. The method according to claim 1, wherein the bromine containing reagent is provided in an aqueous form.

6. The method according to claim 1, wherein the bromine containing reagent is provided in a solid form.

7. The method according to claim 1, wherein the bromine containing reagent is provided in a gaseous form.

8. The method according to claim 3, further comprising the step of pulverizing the fossil fuel.

9. The method according to claim 8, wherein the pulverizing step occurs after the treating step.

10. The method according to claim 2, wherein the coal is treated with up to about 1000 ppm of bromine from the bromine containing reagent.

11. The method according to claim 10, wherein the coal is treated with between about 100 and about 200 ppm of bromine from the bromine containing reagent.

12. The method according to claim 1, wherein a substantial portion of the elemental mercury in the flue gas is oxidized.

13. The method according to claim 1, further comprising the step of using a wet flue gas desulfurization apparatus to remove a substantial portion of the oxidized mercury from the flue gas.

14. The method according to claim 1, further comprising the step of using a spray dryer flue gas desulfurization apparatus to remove a substantial portion of the oxidized mercury from the flue gas.

15. The method according to claim 1, further comprising the step of using a sorbent injection system to remove a substantial portion of the oxidized mercury from the flue gas.

16. The method according to claim 15, wherein the sorbent comprises powdered activated carbon.
